(19) United States
(12) Patent Application Publication
(10) Pub. No.: US 2010/0165231 A1
(43) Pub. Date: Jul. 1, 2010

(54) BACKLIGHT MODULE AND DISPLAY MODULE

(75) Inventors: Chung-Hsing Ho, Kaohsiung County (TW); Ching-Lung Chang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taoyuan (TW)

(21) Appl. No.: 12/544,236

(22) Filed: Aug. 20, 2009

(30) Foreign Application Priority Data
Dec. 25, 2008 (TW) 97150578

(51) Int. Cl. G02F 1/1333; G09F 13/04

(52) U.S. Cl. 349/58; 362/97.1

(57) ABSTRACT

The present invention provides a backlight module and a display module employing the backlight module. The display module includes a backlight component, a panel and a side-cover. The backlight module includes an upper-frame composed of a principal body and an extending portion, and a backlight component. A fillister is formed between the principal body and the extending portion to accommodate the panel, wherein the panel is inserted into and fixed in the display module by means of the fillister and the side-cover.

### CROSS-REFERENCE TO RELATED APPLICATION

This application claims the priority benefit of Taiwan application serial no. 97150578, filed on Dec. 25, 2008. The entirety of the above-mentioned patent application is hereby incorporated by reference herein and made a part of specification.

### BACKGROUND OF THE INVENTION

1. Field of the Invention

The present invention generally relates to a backlight module and a display module, and more particularly, to a backlight module having a plastic upper-frame and a display module employing the above-mentioned backlight module.

2. Description of Related Art

The rapidly growing demand on displays from the market encourages the relevant manufactures to fully devote themselves to the development of displays. Among various display types, due to the excellent display quality and the to have the characteristics of anti-vibration and hit-proof, the one employing a cathode ray tube (CRT) almost monopolized the display market for long time. However, in recent years, the increasing green environmental awareness has had a negative impact on the CRT display based on the inherent disadvantages of CRT, such as high energy consumption and radiation and the space limitation for slimming a display product. Hence, the above-mentioned disadvantages make the traditional CRT fail to meet the display market tendency for chasing light, slim, short, small and stylish product figures and reducing the power consumption. On the contrary, thin film transistor liquid crystal displays (TFT-LCD displays), due to the great advantages thereof, such as high display quality, high space utilization, low power consumption and no radiation, have played a major role in the mainstream display market.

The current design tendency of a display rests in reducing the thickness of the display module or backlight module thereof and the number of the employed components so as to realize slimming figure and reduce the material cost. FIG. 1 is a cross-sectional structure diagram of a conventional display module. Referring to FIG. 1, a display module 7 includes a front-frame 4, a panel 1, a backlight module 3 and a rear-cover 6, wherein the panel 1 is electrically connected to a driving board 5 and the backlight module 3 further includes a plastic frame 2. The panel 1 is clamped between the plastic frame 2 of the backlight module 3 and the front-frame 4 and the driving board 5 is fixed by the rear-cover 6 on the backlight module 3.

Since the front-frame is made of metal material. In order to expose the display region of the panel, the middle portion of the front-frame must be cut-off and get hollow. In term of material utilization rate, the above-mentioned prior art has the disadvantage of wasting material and cost.

### SUMMARY OF THE INVENTION

The goal of the present invention is to reduce the number of combination components, the labor-hours for assembling and the material cost of a backlight module and a display module employing the backlight module to thereby increase the production efficiency.

Accordingly, the present invention is directed to a backlight module for increasing the production efficiency.

The present invention is also directed to a display module for increasing the production efficiency.

The present invention provides a backlight module, which includes a backlight component and an upper-frame, wherein the backlight component has a bottom plate, and the upper-frame has a principal body and an extending portion. The extending portion is disposed on a part of the surface of the principal body so as to form a fillister, wherein the upper-frame is clamped by the panel and the bottom plate from two opposite directions, and an end of the panel is inserted into the fillister.

In an embodiment of the present invention, the material of the above-mentioned upper-frame is plastic or rubber.

In an embodiment of the present invention, the above-mentioned upper-frame is integrated formed.

In an embodiment of the present invention, the above-mentioned upper-frame and bottom plate are fixed by each other through one of screwing, adhering and locking or a combination way thereof.

In an embodiment of the present invention, the above-mentioned backlight component is a direct-type backlight component or a side-type backlight component.

In an embodiment of the present invention, the above-mentioned backlight component further includes at least an optical film and the optical film is disposed between the bottom plate and the upper-frame.

The display module of the present invention includes a backlight module and a side-cover, wherein the backlight module includes a backlight component and an upper-frame, the backlight component has a bottom plate and an upper-frame. The upper-frame has a principal body and an extending portion. The extending portion is disposed on a part of the surface of the principal body so as to form a fillister, wherein the upper-frame is clamped by the panel and the bottom plate from two opposite directions, the fillister is inserted into an end of the panel, and the side-cover is disposed at another end of the panel with inserting way. The side-cover and the extending portion of the upper-frame are adjacently disposed at the both opposite sides of a display region.

In an embodiment of the present invention, the material of the above-mentioned upper-frame is plastic or rubber.

In an embodiment of the present invention, the above-mentioned upper-frame is integrated formed.

In an embodiment of the present invention, the above-mentioned upper-frame and bottom plate are fixed by each other through one of screwing, adhering and locking or a combination way thereof.

In an embodiment of the present invention, the above-mentioned backlight component is a direct-type backlight component or a side-type backlight component.

In an embodiment of the present invention, the above-mentioned backlight component further includes at least an optical film and the optical film is disposed between the bottom plate and the upper-frame.

In an embodiment of the present invention, the above-mentioned panel is a liquid crystal display panel.

In an embodiment of the present invention, the above-mentioned panel is electrically connected to a driving section and the driving section is disposed between the bottom plate and the side-cover.

In an embodiment of the present invention, the above-mentioned panel and the driving section are respectively electrically connected to a flexible circuit board.

In an embodiment of the present invention, the above-mentioned side-cover and backlight module are fixed by each other through one of screwing, adhering and locking or a combination way thereof.

In an embodiment of the present invention, the above-mentioned side-cover is made of metal material.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional structure diagram of a conventional display module.

FIG. 2 is a cross-sectional structure diagram of a backlight module according to the present invention.

FIGS. 3A-3B are cross-sectional structure diagrams of a display module during assembling according to the present invention.

FIG. 4A is a top-view diagram of a display module according to the present invention.

FIG. 4B is a bottom-view diagram of a display module according to the present invention.

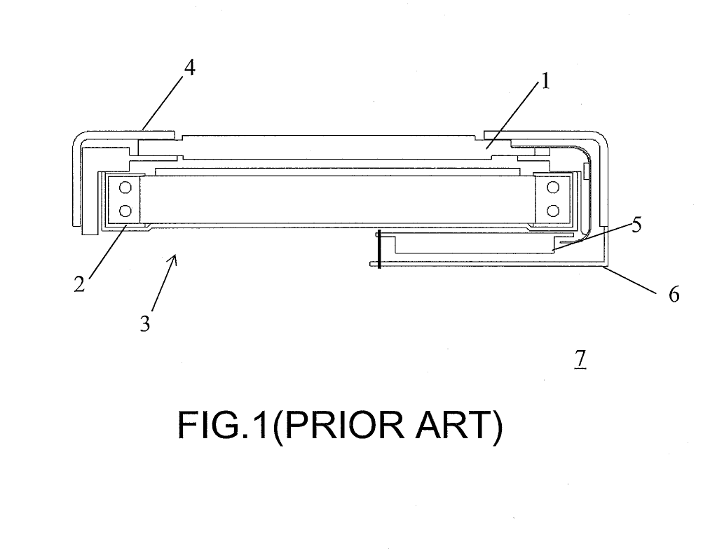

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

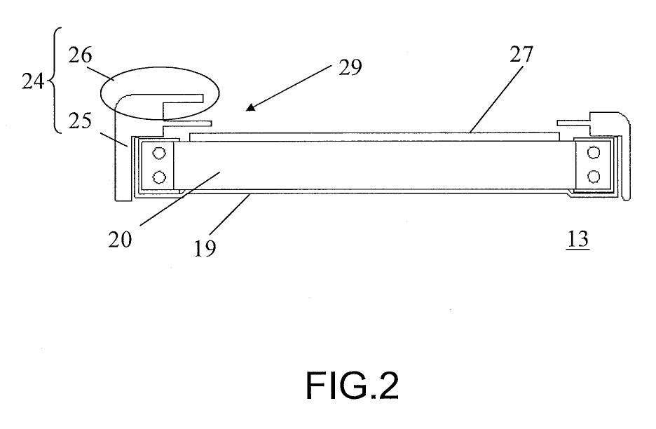

FIG. 2 is a cross-sectional structure diagram of a backlight module according to the present invention. Referring to FIG. 2, the backlight module 13 includes a backlight component 20 having a bottom plate 19 and an upper-frame 24 having a principal body 25 and an extending portion 26. The extending portion 26 is disposed on a part of the surface of the principal body 25 to form a fillister 29, wherein the upper-frame 24 is clamped by the bottom plate 19 and the panel 11 from two opposite directions. In the embodiment, the extending portion 26 is at least partially disposed on a side-edge of the principal body 25 of the upper-frame 24; preferably, the extending portion 26 is disposed on a side-edge surface of the principal body 25 and on the partial surfaces of other two side-edges respectively adjacent to the above-mentioned side-edge so as to form an U-shape extending portion 26. The U-shape extending portion 26 and the principal body 25 of the upper-frame 24 together form a fillister 29.

In a preferred embodiment, the upper-frame 24 is a rectangular frame made of plastic or rubber (in the embodiment, the upper-frame 24 is made of plastic). The backlight component can be a direct-type backlight component or a side-type backlight component. The backlight component 20 further includes at least an optical film 27, which is disposed between the bottom plate 19 and the upper-frame 24.

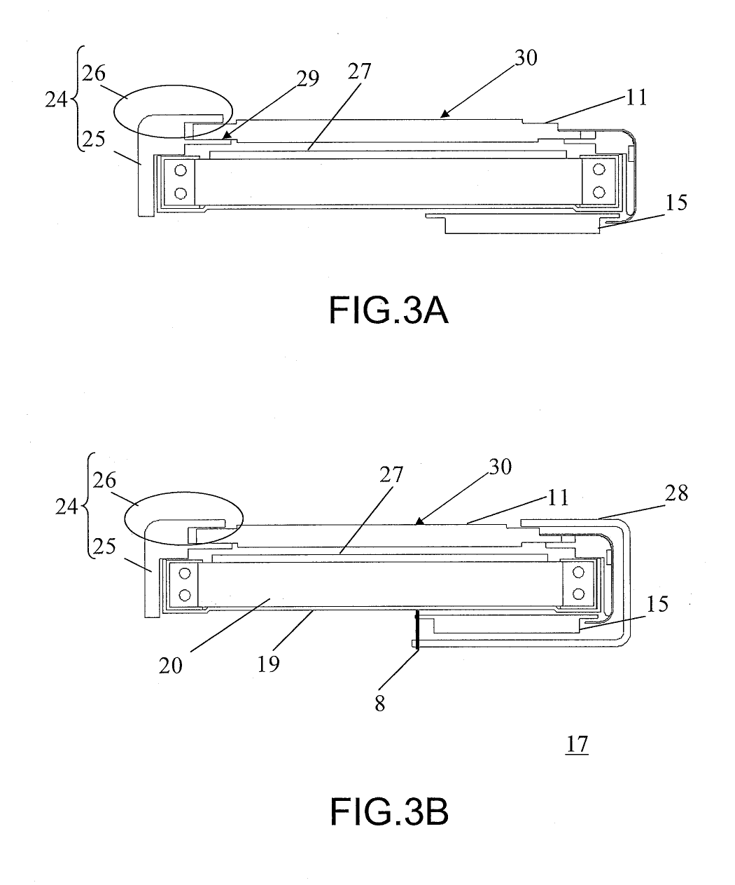

In a preferred embodiment, the principal body 25 and the extending portion 26 in the upper-frame 24 are integrated formed and fabricated by means of stamping forming, injection molding or double-components injection molding. The principal body 25 and the extending portion 26 can be made of different materials, respectively, wherein the extending portion 26 is preferably made of elastic material with the characteristics of anti-vibration and hit-proof. However, the present invention does not limit the extending portion 26 to be formed to the above-mentioned way; i.e., the extending portion 26 can be independently disposed from the upper-frame 24. The upper-frame 24 and the bottom plate 19 are fixed by each other through one of screwing, adhering and locking or a combination way thereof. FIGS. 3A-3B are cross-sectional structure diagrams of a display module during assembling according to an embodiment of the present invention. The backlight module 13 having the fillister 29 and the application thereof in a display module can refer FIGS. 3A and 3B.

Referring to FIGS. 3A and 3B, in the embodiment, the same reference numbers are used in the drawings and the description to refer to the same or like functions/structures, and the same depictions are omitted for simplicity. Referring to FIG. 3A, a semi-finished assembly of a display module 17 is shown, which includes a backlight module 13 with a fillister 29 and a panel 11 with a display region 30. The major deference of FIG. 3A from FIG. 2 rests in that a side of the panel 11 with the display region 30 is inserted and positioned within the fillister 29. Referring to FIG. 3B, the finished assembly of the display module 17 is shown. The major deference of FIG. 3B from FIG. 3A rests in that the side-cover 28 is tightly inserted in the panel 11 and disposed at another side of the panel 11. The side-cover 28 and the extending portion 26 of the upper-frame 24 are disposed at the two opposite sides of the display region 30, so that the panel 11 is inserted and fixed into the display module 17 by means of the fillister 29 and the side-cover 28.

The panel 11 is a flat display panel and, preferably, is an LCD panel. The panel 11 and the bottom plate 19 together clamp the upper-frame 24 from two opposite directions. The panel 11 is electrically connected to a driving section 15 through a flexible circuit board (FCB) or a signal wire, which the present invention is not limited to. In addition, the driving section 15 is disposed between the bottom plate 19 and the side-cover 28, wherein the side-cover 28 is made of metal. The side-cover 28 and the backlight module 13 are fixed by each other through one of screwing, adhering and locking or a combination way thereof, and the fixing position and the number thereof are not limited by the present invention. For example, in the embodiment, the side-cover 28 and the bottom plate 19 are fixed by each other by screwing a screw 8.

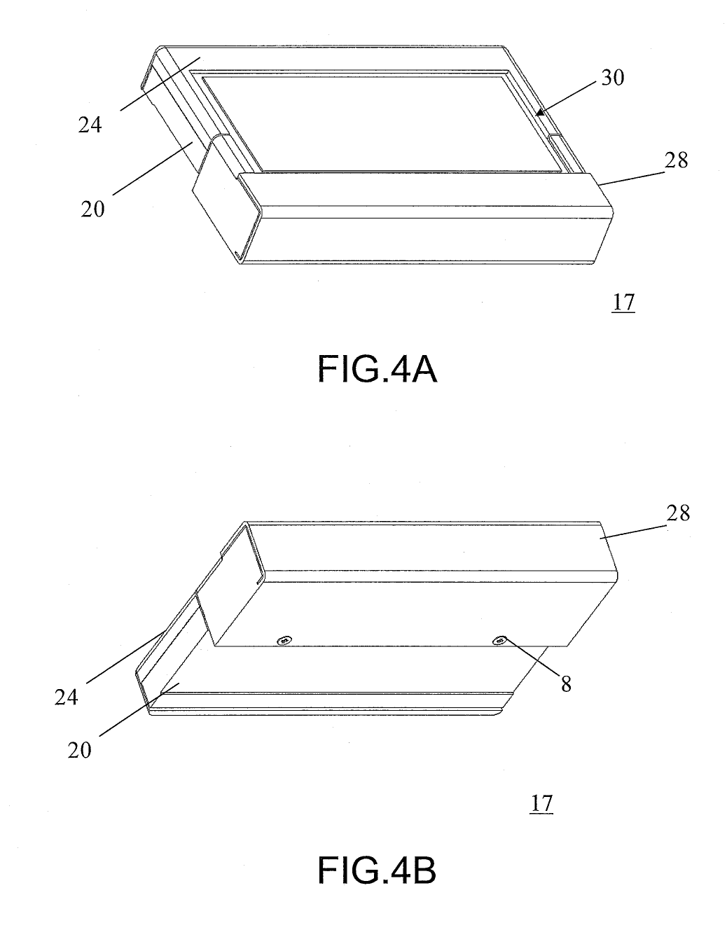

FIG. 4A is a top-view diagram of a display module according to the present invention and FIG. 4B is a bottom-view diagram of a display module according to the present invention. Referring to FIGS. 4A and 4B, in the embodiment, the same reference numbers are used in the drawings and the description to refer to the same or like functions/structures, and the same depictions are omitted for simplicity. The extending portion 26 of the upper-frame 24 and the side-cover 28 cover the periodical area of the panel 11, but the display region 30 of the panel 11 is exposed. It is preferable the upper-frame 24 and the side-cover 28 are flashed with each other.

In summary, the advantage of the present invention is achieved by employing the above-mentioned upper-frame in accordance with the conventional front-frame and plastic frame. Based on the above-mentioned design and the function thereof and the rear-cover is changed to the side-cover, the design of the present invention reduces the number of combination components, saves the material cost and the labor-hours for assembling and thereby increases the production efficiency. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A backlight module, suitable to be used in accordance with a panel having a display region, the backlight module comprising:
a backlight component, having a bottom plate; and
an upper-frame, having a principal body and an extending portion, wherein the extending portion is disposed on a part of the surface of the principal body so as to form a fillister, the upper-frame is clamped by the bottom plate and the panel from two opposite directions, and a side of the panel is inserted into the fillister.

2. The backlight module as claimed in claim 1, wherein the material of the upper-frame is plastic or rubber.

3. The backlight module as claimed in claim 2, wherein the upper-frame is integrated formed.

4. The backlight module as claimed in claim 1, wherein the upper-frame and the bottom plate are fixed by each other through one of screwing, adhering and locking or a combination way thereof.

5. The backlight module as claimed in claim 1, wherein the backlight component is a direct-type backlight component or a side-type backlight component.

6. The backlight module as claimed in claim 1, wherein the backlight component further comprises at least an optical film and the optical film is disposed between the bottom plate and the upper-frame.

7. A display module, comprising:
a backlight module, comprising:
a backlight component, having a bottom plate; and
an upper-frame, having a principal body and an extending portion, wherein the extending portion is disposed on a part of the surface of the principal body so as to form a fillister;
a panel, having a display region, wherein the panel and the bottom plate clamp the upper-frame from two opposite directions, and a side of the panel is inserted into the fillister; and
a side-cover, disposed through insertion at another side of the panel, wherein the side-cover and the extending portion of the upper-frame are adjacently disposed at the both opposite sides of the display region.

8. The display module as claimed in claim 7, wherein the material of the upper-frame is plastic or rubber.

9. The display module as claimed in claim 8, wherein the upper-frame is integrated formed.

10. The display module as claimed in claim 7, wherein the upper-frame and the bottom plate are fixed by each other through one of screwing, adhering and locking or a combination way thereof.

11. The display module as claimed in claim 7, wherein the backlight component is a direct-type backlight component or a side-type backlight component.

12. The display module as claimed in claim 7, wherein the backlight component further comprises at least an optical film and the optical film is disposed between the bottom plate and the upper-frame.

13. The display module as claimed in claim 7, wherein the panel is a liquid crystal display panel.

14. The display module as claimed in claim 7, wherein the panel is electrically connected to a driving section and the driving section is disposed between the bottom plate and the side-cover.

15. The display module as claimed in claim 14, wherein the panel and the driving section are respectively electrically connected to a flexible circuit board.

16. The display module as claimed in claim 7, wherein the side-cover and the backlight module are fixed by each other through one of screwing, adhering and locking or a combination way thereof.

17. The display module as claimed in claim 7, wherein the side-cover is made of metal material.
